(19) United States
(12) Patent Application Publication
(10) Pub. No.: US 2020/0099102 A1
(43) Pub. Date: Mar. 26, 2020

(54) ACTIVE MATERIAL AND FLUORIDE ION BATTERY

(71) Applicant: TOYOTA JIDOSHA KABUSHIKI KAISHA, Toyota-shi (JP)

(72) Inventor: Hirofumi Nakamoto, Susono-shi (JP)

(73) Assignee: TOYOTA JIDOSHA KABUSHIKI KAISHA, Toyota-shi (JP)

(21) Appl. No.: 16/546,638

(22) Filed: Aug. 21, 2019

(30) Foreign Application Priority Data
Sep. 20, 2018 (JP) 2018-176517

(51) Int. Cl. H01M 10/0567; H01M 4/36; H01M 10/0568; H01M 10/0569

(52) U.S. Cl. CPC H01M 10/0567; H01M 4/366; H01M 2300/0034; H01M 10/0569; H01M 10/0568

(57) ABSTRACT

A main object of the present disclosure is to provide an active material of which capacity properties are excellent. The present disclosure achieves the object by providing an active material to be used for a fluoride ion battery, the active material comprising: a metal part containing a metal element and capable of reaction with a fluoride ion; wherein in O1s spectrum obtained by measuring a surface of the active material with an X-ray photoelectron spectroscopy, when an intensity at 531.0 eV is regarded as I_{A} and an intensity at a peak derived from an oxide of the metal element is regarded as I_{B}, I_{B}/I_{A} is 0 or more and 1 or less.

### TECHNICAL FIELD

The present disclosure relates to an active material and a fluoride ion battery.

### BACKGROUND ART

Li ion batteries have been known as a battery with a high voltage and high energy density for example. The Li ion battery is a cation based battery utilizing the reaction of Li ions with cathode active materials, and the reaction of Li ions with anode active materials. On the other hand, fluoride ion batteries have been known as an anion based battery that utilizes the reaction of fluoride ions (fluoride anions).

For example, Patent Literature 1 discloses a fluoride ion battery using a metal active material. Also, Patent Literature 2 discloses a fluoride ion battery provided with a cathode active material comprising: an active material containing at least one kind of Ag, Co, Mn, Cu, W, and V; and a fluoride that coats the active material.

Meanwhile, although it is not a technique relating to a fluoride ion battery, Patent Literature 3 discloses a storage element comprising: an active material particle containing at least lithium and transition metal; and a coating layer that covers the active material particle and includes a carbonaceous material and silicon. Also, Patent Literature 4 discloses a nonaqueous electrolyte battery comprising an active material particle covered with a lithium ion conductive glass.

### CITATION LIST

### Patent Literatures

Patent Literature 1: Japanese Patent Application Laid-Open (JP-A) No. 2016-062821

Patent Literature 2: JP-A No. 2018-063905

Patent Literature 3: JP-A No. 2015-109227

Patent Literature 4: JP-A No. 2003-170770

### SUMMARY OF DISCLOSURE

### Technical Problem

An active material with excellent capacity properties has been demanded as an active material to be used for a fluoride ion battery. The present disclosure has been made in view of the above circumstances, and a main object thereof is to provide an active material of which capacity properties are excellent.

### Solution to Problem

To achieve the above object, the present disclosure provides an active material to be used for a fluoride ion battery, the active material comprising: a metal part containing a metal element and capable of reaction with a fluoride ion; wherein, in O1s spectrum obtained by measuring a surface of the active material with an X-ray photoelectron spectroscopy, when an intensity at 531.0 eV is regarded as I_{A} and an intensity at a peak derived from an oxide of the metal element is regarded as I_{B}, I_{B}/I_{A} is 0 or more and 1 or less.

According to the present disclosure, I_{B}/I_{A} in the specific range allows an active material to have excellent capacity properties.

In the disclosure, the active material may comprise the metal part and a coating part that covers the metal part.

In the disclosure, in O1s spectrum obtained by measuring an interface between the metal part and the coating part with an X-ray photoelectron spectroscopy, when an intensity at 531.0 eV is regarded as I_{C} and an intensity at a peak derived from an oxide of the metal element is regarded as I_{D}, I_{D}/I_{C} may be 0 or more and 1 or less.

In the disclosure, the coating part may be a carbon coating part.

In the disclosure, the active material may contain a Co element as the metal element.

In the disclosure, a magnetic susceptibility of the active material may be 100 emu/g or more.

Also, the present disclosure provides a fluoride ion battery comprising a cathode active material layer, an anode active material layer, and an electrolyte layer formed between the cathode active material layer and the anode active material layer; wherein at least one of the cathode active material layer and the anode active material layer contains the above described active material.

According to the present disclosure, usage of the above described active material allows a fluoride ion battery to have excellent capacity properties.

### Advantageous Effects of Disclosure

The present disclosure exhibits effects such as to provide an active material of which capacity properties are excellent.

### BRIEF DESCRIPTION OF DRAWINGS

FIGS. 1A and 1B are schematic cross-sectional views exemplifying the active material in the present disclosure.

FIG. 2 is a schematic cross-sectional view illustrating an example of a fluoride ion battery in the present disclosure.

FIG. 3 is the result of an XPS measurement for the active materials used in Examples 1, 2, and Comparative Example 1.

FIG. 4 is the result of a CP measurement for the evaluation electrodes obtained in Examples 1, 2, Comparative Examples 1 and 2.

FIG. 5 is the result of a CP measurement for the evaluation electrodes obtained in Examples 1 and 2.

### DESCRIPTION OF EMBODIMENTS

The active material and the fluoride ion battery of the present disclosure are hereinafter described in details.

A. Active Material

The active material in the present disclosure is an active material to be used for a fluoride ion battery, the active material comprising: a metal part containing a metal element and capable of reaction with a fluoride ion; wherein, in O1s spectrum obtained by measuring a surface of the active material with an X-ray photoelectron spectroscopy, when an intensity at 531.0 eV is regarded as I_{A} and an intensity at a peak derived from an oxide of the metal element is regarded as I_{B}, I_{B}/I_{A} is 0 or more and 1 or less.

According to the present disclosure, I_{B}/I_{A} in the specific range allows the active material to have excellent capacity properties. For example, Patent Literature 1 discloses a metal active material to be used for a fluoride ion battery. However, an oxide film is easily formed on the surface of the metal active material. The oxide film becomes resistance and easily degrades capacity properties. Also, there is a possibility that oxygen elements included in the oxide film spread inside the metal active material, which easily degrades capacity properties. To solve the problem, in the present disclosure, I_{B}/I_{A} is in the specific range. This specifies that the proportion of the oxide film present on the surface of the active material is less than that in conventional active materials. The proportion of the oxide film is small, or the oxide film is not present and thus the capacity properties are inhibited from being degraded.

The metal part in the present disclosure is a part containing a metal element and capable of reaction with a fluoride ion. Also, the metal part is a part that mainly exhibits a function as an active material. In other words, the metal part is a part where a battery reaction with a fluoride ion occurs. An oxide film is easily formed on the surface of the metal part, but an oxygen element is preferably not present in the central part of the metal part. Examples of the metal part may include a simple substance of metal and a metal alloy.

Examples of the metal element in the metal part may include Co, Fe, Cu, Ni, Al, Mg, Ce, La, Ca, and Ti, and among them, Co, Fe, and Cu are preferable. The metal part may contain the metal element solely and may contain two kinds or more thereof. Also, when the metal part is an alloy, the metal part preferably contains one of the metal elements as a main component. The proportion of the metal element in an alloy is, for example, 50 weight % or more, may be 70 weight % or more, and may be 90 weight % or more.

In particular, the metal part in the present disclosure preferably contains at least a Co element. In this case, the metal part may be a simple substance of Co, and may be a Co alloy. Further, the latter case is preferably an alloy of which main component is Co. The preferable proportion of the Co element in the Co alloy is in the same contents as described above.

In the present disclosure, it is specified that the metal oxide (oxide film) present on the surface of the active material is little using O1s spectrum with an XPS measurement. Here, in O1s spectrum, the main peak of an oxygen (O) element appears at 531 eV. Accordingly, as a reference, intensity at 531.0 eV is applied and the intensity is regarded as I_{A}. Incidentally, the intensity is specified as a height from the base line. Meanwhile, in the metal oxide, a M-O bond is formed and the main peak of an oxygen (O) element shifts from 531 eV. Then, the intensity at a peak derived from an oxide of the metal element is regarded as I_{B}. Incidentally, the peak derived from the oxide may be specified from the peak of the reference standard of the oxide (for example, if the target is a Co element, the reference standard of CoO, and Co₃O₄). Also, the smaller ratio of I_{B} to I_{A}(I_{B}/I_{A}) signifies the lesser oxide film.

In the present disclosure, I_{B}/I_{A} is 0 or more. It means that I_{B}/I_{A} may be 0 and may be more than 0. In the latter case, I_{B}/I_{A} is, for example, 0.05 or more. Meanwhile, I_{B}/I_{A} is, for example, 1 or less, may be 0.8 or less, may be 0.7 or less, and may be 0.6 or less.

Also, on the surface of the active material, the peak derived from the oxide of the metal element in the metal part may be observed and may not be observed, but the latter is preferable. The reason therefor is because the oxide film not being present improves the capacity properties of the active material. Incidentally, when the peak derived from the oxide of the metal element in the metal part is not observed, it can be judged as I_{B}=0. On the other hand, in the former case, the peak position derived from the oxide of the metal element is preferably distanced from 531.0 eV (position of I_{A}). The reason therefor is to easily specify the peaks. The peak derived from the oxide of the metal element preferably appears at the positions such as 530.5 eV or lower. Also, the peak derived from the oxide of the metal element may appear at the positions such as 531.5 eV or higher.

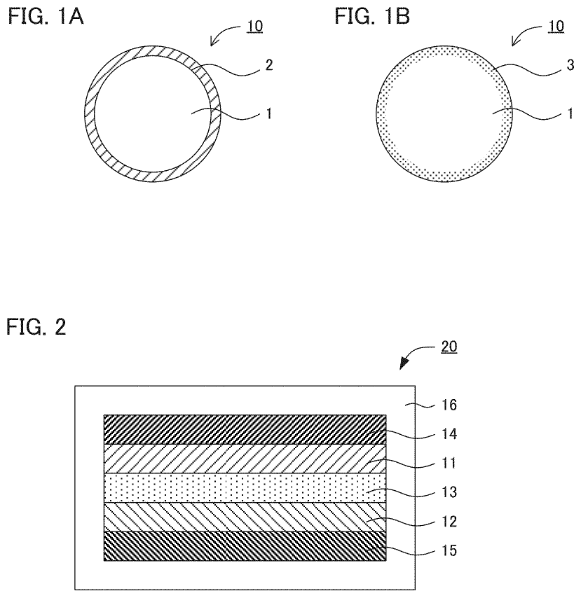

The active material in the present disclosure may comprise a coating part that covers the metal part. For example, active material 10 illustrated in FIG. 1A has metal part 1 and coating part 2 that covers metal part 1. Arranging the coating part allows the active material to have less oxide film present on the surface of the active material. Also, arranging the coating part inhibits the metal part from being oxidized over time. When the active material has the coating part, an interface may be observed on the occasion such as when observing the cross-section of the active material.

An example of the coating part may be a carbon coating part containing a carbon element. The proportion of the carbon element in the carbon coating part is, for example, 50 at % or more, may be 70 at % or more, and may be 90 at % or more. Also, an additional example of the coating part may be a polymer coating part containing a polymer. Also, the coating part may contain a fluoride, and may not contain a fluoride. In the same manner, the coating part may contain a sulfide such as FeS, and may not contain a sulfide.

There are no particular limitations on the thickness of the coating part; for example, it is 50 nm or less, may be 30 nm or less, and may be 10 nm or less. Meanwhile, the thickness of the coating part is, for example, 1 nm or more. Also, the coverage of the coating part on the surface of the metal part is, for example, 50% or more, maybe 70% or more, and may be 90% or more. Also, the electron conductivity of the coating part at 25° C. is, for example, preferably 10⁻⁵ S/cm or more.

Also, when the active material has the metal part and the coating part, it is preferable that the metal oxide (oxide film) present in the interface between the metal part and the coating part is little. The reason therefor is to allow the active material to have excellent capacity properties. In specific, in O1s spectrum obtained by measuring an interface between the metal part and the coating part with an X-ray photoelectron spectroscopy, when an intensity at 531.0 eV is regarded as I_{C} and an intensity at a peak derived from an oxide of the metal element is regarded as I_{D}, I_{D}/I_{C} is preferably 0 or more and 1 or less. For example, if the oxide film is present on the surface of the metal part before forming the coating part, the oxide film is present in the interface and there is a possibility that the capacity properties may be degraded. To solve the problem, the value of I_{D}/I_{C} being low in the interface inhibits the capacity properties from being degraded. The preferable range of I_{D}/I_{C} is the same as the above described range of I_{B}/I_{A}; thus, the description herein is omitted. Also, it is preferable that the peak derived from the oxide of the metal element is not observed in the interface.

Meanwhile, the active material in the present disclosure may have an oxidation resistance region in the inner surface of the metal part. For example, active material 10 illustrated in FIG. 1B has metal part 1 and oxidation resistance region 3 in the inner surface of the metal part. Arranging the oxidation resistance region allows the active material to have less metal oxide (oxide film) present on the surface of the active material. Also, the oxidation resistance region may be formed by, for example, depositing the metal element not easily oxidized in the inner surface of the metal part.

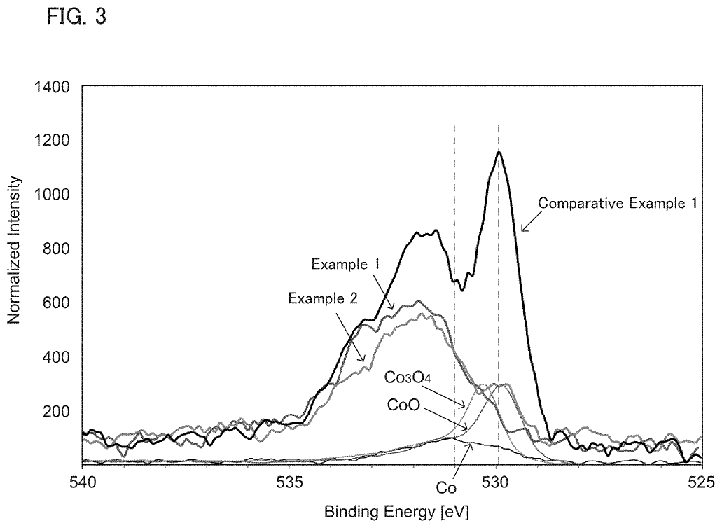

Also, in the later described FIG. 3, although a broad peak was confirmed in the vicinity of 532 eV, this peak is presumably a peak of an oxygen-containing group (such as OH group, CO group, and CO₃ group) present on the surface of the active material. In this manner, in the present disclosure, the peak derived from an oxygen-containing group may be present at the position of 531.5 eV or higher. In O1s spectrum obtained by measuring a surface of the active material with an X-ray photoelectron spectroscopy, when the intensity at the peak of the oxygen-containing group is regarded as I_{E} and the intensity at a peak derived from an oxide of the metal element is regarded as I_{B}, I_{E}/I_{B} is preferably 0 or more and 1 or less. The preferable range of I_{E}/I_{B} is the same as the above described range of I_{B}/I_{A}; thus, the description herein is omitted.

The magnetic susceptibility of the active material in the present disclosure is preferably high. High magnetic susceptibility inhibits the formation of the oxide film. The magnetic susceptibility of the active material is, for example, 50 emu/g or more, may be 100 emu/g or more, and may be 150 emu/g or more. Meanwhile, the magnetic susceptibility of the active material is, for example, 250 emu/g or less. In particular, when the active material contains Co as the metal element, the magnetic susceptibility of the active material is, for example, 100 emu/g or more, and may be 150 emu/g or more. Also, when the active material contains Fe as the metal element, the magnetic susceptibility of the active material is, for example, 100 emu/g or more, and may be 200 emu/g or more. The magnetic susceptibility of the active material may be determined by, for example, a Faraday method.

Examples of the shape of the active material may include a granular shape. The average particle size (D₅₀) of the active material is, for example, 1 nm or more, and may be 5 nm or more. Meanwhile, the average particle size (D₅₀) of the active material is, for example, 10 μm or less, may be 5 μm or less, may be 1 μm or less, may be 500 nm or less, and may be 100 nm or less.

Incidentally, the average particle size (D₅₀) may be calculated from the measurement by, for example, a scanning electron microscope (SEM) or a transmission electron microscope (TEM). The number of samples is preferably a lot; for example, it is 100 or more.

B. Fluoride ion battery

FIG. 2 is a schematic cross sectional view illustrating an example of the fluoride ion battery in the present disclosure. Fluoride ion battery 20 shown in FIG. 2 comprises cathode active material layer 11, anode active material layer 12, electrolyte layer 13 formed between cathode active material layer 11 and anode active material layer 12, cathode current collector 14 for collecting currents of cathode active material layer 11, anode current collector 15 for collecting currents of anode active material layer 12, and battery case 16 for storing these members. In the present disclosure, at least one of cathode active material layer 11 and anode active material layer 12 contains the above described active material.

According to the present disclosure, usage of the above described active material allows a fluoride ion battery to have excellent capacity properties. Incidentally, in the present disclosure, just the cathode active material layer may contain the above described active material, and just the anode active material layer may contain the above described active material. Also, both of the cathode active material layer and the anode active material layer may contain the above described active material; however, in that case, among the above described active materials, the active material with high reaction potential is used as the cathode active material, and the active material with low reaction potential is used as the anode active material.

1. Cathode Active Material Layer

The cathode active material layer in the present disclosure is a layer containing at least a cathode active material. Also, the cathode active material layer may further contain at least one of a conductive material and a binder other than the cathode active material.

The cathode active material layer preferably contains the active material described in “A. Active material” above as a cathode active material. In this case, an arbitrary active material with lower reaction potential than that of the above described active material may be used as an anode active material. Meanwhile, when the active material described in “A. Active material” above is used as the anode active material, general cathode active materials may be used. Examples of the general cathode active materials may include a simple substance of metal, an alloy, a metal oxide, and fluorides of these.

There are no particular limitations on the conductive material if it has the desired electron conductivity, and examples thereof may include a carbon material. Examples of the carbon material may include carbon blacks such as acetylene black, Ketjen black, furnace black and thermal black; graphene, fullerene, and carbon nanotube. Meanwhile, there are no particular limitations on the binder if it is chemically and electronically stable, and examples thereof may include a fluorine-based binder such as polyvinylidene fluoride (PVDF) and polytetrafluoroethylene (PTFE).

Also, the content of the cathode active material in the cathode active material layer is preferably larger from the viewpoint of the capacity; for example, the content is 30 weight % or more, preferably 50 weight % or more, and more preferably 70 weight % or more. Also, the thickness of the cathode active material layer is, for example, 0.1 μm or more and 1000 μm or less.

2. Anode Active Material Layer

The anode active material layer in the present disclosure is a layer containing at least an anode active material. Also, the anode active material layer may further contain at least one of a conductive material and a binder other than the anode active material.

The anode active material layer preferably contains the active material described in “A. Active material” above as an anode active material. In this case, an arbitrary active material with higher reaction potential than that of the above described active material may be used as a cathode active material. Meanwhile, when the active material described in “A. Active material” above is used as the cathode active material, general anode active materials may be used. Examples of the general anode active materials may include a simple substance of metal, an alloy, a metal oxide, and fluorides of these.

Regarding the conductive material and the binder, the same materials described in “1. Cathode active material layer” above may be used. Also, the content of the anode active material in the anode active material layer is preferably larger from the viewpoint of the capacity; for example, the content is 30 weight % or more, preferably 50 weight % or more, and more preferably 70 weight % or more. Also, the thickness of the anode active material layer is, for example, 0.1 μm or more and 1000 μm or less.

3. Electrolyte Layer

The electrolyte layer in the present disclosure is a layer formed between the cathode active material layer and the anode active material layer. The electrolyte configured in the electrolyte layer may be a liquid electrolyte (electrolyte solution), may be a polymer electrolyte, and may be an inorganic solid electrolyte.

The electrolyte solution contains, for example, a fluoride salt and a solvent. Examples of the fluoride salt may include an inorganic fluoride salt, an organic fluoride salt, and an ionic liquid. Examples of the inorganic fluoride salt may include XF (X is Li, Na, K, Rb or Cs). Examples of the cation of the organic fluoride salt may include an alkyl ammonium cation such as a tetramethyl ammonium cation. The concentration of the fluoride salt in the electrolyte solution is, for example, 0.1 mol/L or more, may be 0.3 mol/L or more, and may be 0.5 mol/L or more. Meanwhile, the concentration of the fluoride salt is, for example, 6 mol/L or less, and may be 3 mol/L or less.

Examples of the solvent may include a cyclic carbonate such as ethylene carbonate (EC), fluoro ethylene carbonate (FEC), difluoro ethylene carbonate (DFEC), propylene carbonate (PC), and butylene carbonate (BC); a chain carbonate such as dimethyl carbonate (DMC), diethyl carbonate (DEC), and ethyl methyl carbonate (EMC); a chain ether such as diethyl ether, 1,2-dimethoxymethane, and 1,3-dimethoxypropane; a cyclic ether such as tetrahydrofuran and 2-methyltetrahydrofuran; a cyclic sulfone such as sulfolane, a chain sulfone such as dimethyl sulfoxide (DMSO); a chain ester such as γ-butyrolactone; a nitrile such as acetonitrile; and an arbitrary mixture of these.

Also, an additional example of the chain ether may include glyme. Specific examples of the glyme may include diethylene glycol diethyl ether (G2), triethylene glycol dimethyl ether (G3), tetraethylene glycol dimethyl ether (G4), diethylene glycol dibutyl ether, diethylene glycol methyl ethyl ether, triethylene glycol methyl ethyl ether, and triethylene glycol butyl methyl ether. Also, an ionic liquid may be used as the solvent.

Also, the electrolyte solution may contain an alkali metal amide salt as required. The alkali metal amide salt usually includes a cation of an alkali metal, and an amide anion. Examples of the alkali metal may include Li, Na, K, Rb, and Cs. Meanwhile, examples of the amide anion may include sulfonyl amide anion. The sulfonyl amide anion is an anion in which N in the amide anion (center of anion) bonds with S in a sulfonyl group. The sulfonyl amide anion may include one sulfonyl group, and may include two thereof. It is preferable that the sulfonyl group bonds with an alkyl group (such as 4 or less carbon atoms), a fluoro alkyl group (such as 4 or less carbon atoms), or a fluorine. Examples of the sulfonyl amide anion may include bis (fluoro sulfonyl) amide (FSA) anion, and bis (trifuloro methane sulfonyl) amide (TFSA) anion.

The concentration of the alkali metal amide salt in the electrolyte solution is, for example, 0.5 mol/L or more, may be 2.5 mol/L or more, and may be 4 mol/L or more. Meanwhile, the concentration of the alkali metal amide salt is, for example, 8 mol/L or less, and may be 6 mol/L or less. Also, the molar ratio (B/A) of the fluoride salt (B) to the alkali metal amide salt (A) is, for example, 0.02 or more, and may be 0.05 or more. Meanwhile, the molar ratio (B/A) is, for example, 1.5 or less, and may be 1 or less.

On the other hand, the polymer electrolyte may be obtained by, for example, adding a polymer to the liquid electrolyte to gelate the liquid electrolyte. Also, examples of the inorganic solid electrolyte may include a fluoride of a lanthanoid element such as La and Ce; a fluoride of an alkaline element such as Li, Na, K, Rb, and Cs; and a fluoride of an alkaline earth element such as Ca, Sr, and Ba.

4. Other Constitutions

The fluoride ion battery in the present disclosure comprises at least the above described cathode active material layer, anode active material layer, and electrolyte layer. The battery usually further comprises a cathode current collector for collecting currents of the cathode active material layer, and an anode current collector for collecting currents of the anode active material layer. Examples of the shape of the current collectors may include a foil shape, a mesh shape, and a porous shape. Also, the fluoride ion battery may comprise a separator between the cathode active material layer and the anode active material layer. The reason therefor is to obtain a battery with higher safety.

5. Fluoride Ion Battery

The fluoride ion battery in the present disclosure may be a primary battery and may be a secondary battery, but preferably is a secondary battery, so as to be repeatedly charged and discharged and useful as a car mounted battery for example. Also, examples of the shape of the fluoride ion battery in the present disclosure may include a coin shape, a laminate shape, a cylindrical shape, and a square shape.

Incidentally, the present disclosure is not limited to the embodiments. The embodiments are exemplification, and other variations are intended to be included in the technical scope of the present disclosure if they have substantially the same constitution as the technical idea described in the claim of the present disclosure and offer similar operation and effect thereto.

### EXAMPLES

The present disclosure is hereinafter described in more details with reference to Examples. Incidentally, production of the samples and evaluation were conducted in a glove box under an Ar atmosphere with the dew point of −100° C. and O₂ concentration of 1 ppm or less.

### Example 1

Magnetized carbon coated nano Co particles (from Aldrich, 697745-500MG, average particle size: 50 nm or less, magnetic susceptibility: 162 emu/g) were prepared as an active material, and acetylene black (AB, from Denki Kagaku Kogyo Kabushiki Kaisha) was prepared as a conductive material. These were mixed by ball milling so as to be the active material:the conductive material=2:1 in the weight ratio to obtain a mixture. On this occasion, the conditions of ball milling were adjusted so as the carbon coat of the active material not to come off. Next, polyvinylidene fluoride (PVdF, from Kureha Battery Materials Japan) was prepared as a binder. After that, the mixture and the binder were mixed so as to be the mixture:the binder=9:0.5 in the weight ratio, and thereby slurry was prepared. The obtained slurry was pasted and dried so as the thickness after drying thereof became approximately 30 μm, and thereby an evaluation electrode was obtained.

### Example 2

An evaluation electrode was obtained in the same manner as in Example 1 except that carbon coated nano Co particles (from Nisshin Engineering Inc., average particle size: 40 nm or less) were used as the active material.

### Comparative Example 1

An evaluation electrode was obtained in the same manner as in Example 1 except that nano Co particles (from Nisshin Engineering Inc., average particle size: 40 nm or less) were used as the active material.

### Comparative Example 2

An evaluation electrode was obtained in the same manner as in Example 1 except that Co₃O₄ coated nano Co particles (from Alfa Aeser, average particle size: 30 nm or less) were used as the active material.

[Evaluations]

<XPS Measurement>

The surfaces of the active materials used in Examples 1, 2, and Comparative Example 1 were measured by an X-ray photoelectron spectroscopy (XPS) using an AlKα-ray with an incident angle of 45°. The obtained O1s spectrums are shown in FIG. 3. Incidentally, in FIG. 3, for comparison, the results of simple substance of Co (zerovalent), CoO (divalent), and Co₃O₄ (divalent and trivalent) are also described.

As shown in FIG. 3, in Comparative Example 1 (nano Co particle not having a coating part), a peak derived from the oxide film of Co was observed in the vicinity of 529.9 eV. Incidentally, in Comparative Example 1, a broad peak was confirmed in the vicinity of 532 eV, but this peak was presumably the peak of an oxygen-containing group (such as OH group, CO group, and CO₃ group) present on the surface of the active material.

Also, when the intensity at 531.0 eV was regarded as I_{A} and the intensity of the peak derived from the oxide film was regarded as I_{B}, I_{B}/I_{A} was larger than 1. In other words, it was confirmed that many oxide films were present on the surfaces of the active materials.

On the other hand, in Example 1 (magnetized carbon coated nano Co particles), the peak derived from the oxide film was not confirmed. Also, regarding the active material used in Example 1, the state of the oxide in the interface between the metal part (Co) and the coating part (carbon) was confirmed using an ion sputtering method, but the peak derived from the oxide film was not confirmed.

Also, in Example 2 (carbon coated nano Co particles), the peak derived from the oxide film was slightly observed in the vicinity of 529.9 eV. When the intensity at 531.0 eV was regarded as I_{A} and the intensity of the peak derived from the oxide film was regarded as I_{B}, I_{B}/I_{A} was 0.6.

<CP Measurement>

A chronopotentiometry (CP) measurement was conducted in a liquid solution using the evaluation electrodes obtained in Examples 1, 2, Comparative Examples 1 and 2.

Regarding the electrolyte solution, with tetra glyme (G4, from Kishida Chemical Co., Ltd.), lithium bis(fluorosulfonyl)amide (Li-FSA, from Kishida Chemical Co., Ltd.) and cesium fluoride (CsF from KANTO CHEMICAL CO., INC.) were mixed so as to be 4.5 M and 0.45 M respectively, and the mixture was stirred in the conditions of, in a sealed container made of a fluorine resin at 30° C., and thereby the electrolyte solution was obtained.

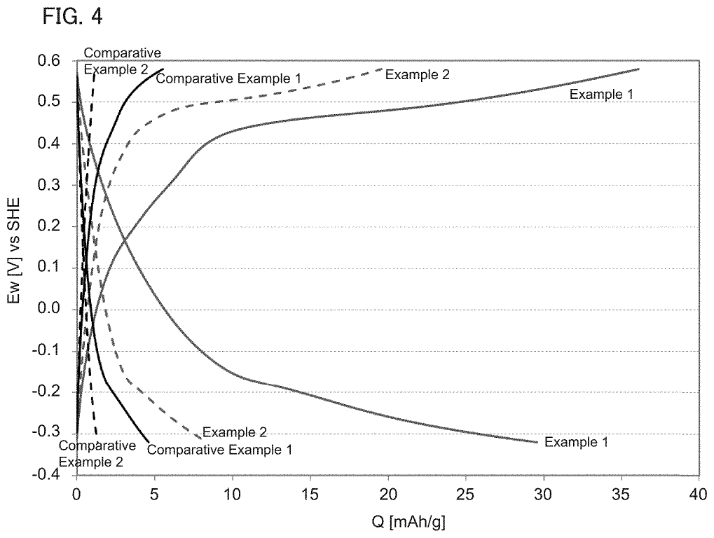

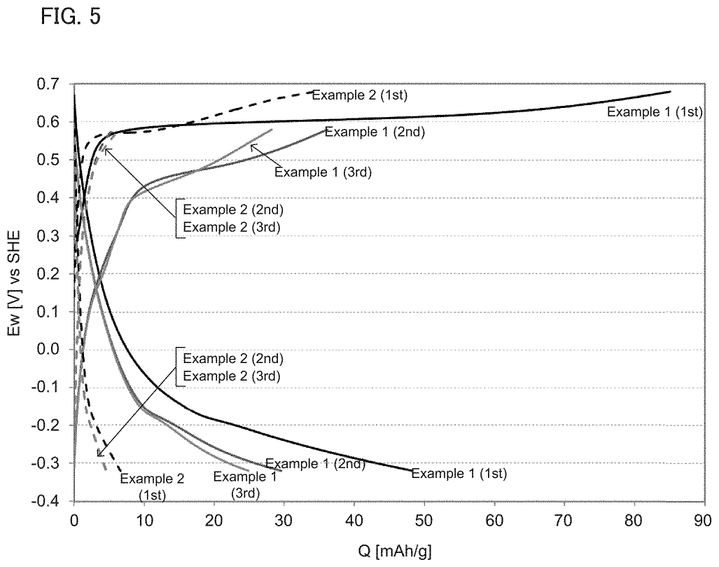

The CP measurement was conducted using a dip-type 3-electrodes cell in a glove box under an Ar atmosphere. The evaluation electrode was used as a working electrode, and a mixture electrode of PTFE, acetylene black (AB), and carbon fluoride was used as a counter electrode. Incidentally, the mixture electrode was an electrode containing the materials in the weight ratio of PTFE:AB:carbon fluoride=1:2:7. Also, a reference electrode was separated from the electrolyte solution using a Vycor glass. Incidentally, the reference electrode used was a Ag line soaked in an acetonitrile solution in which silver nitrate and tetrabutylammoniumperchlorate were dissolved in the concentration of 0.1 M respectively. The measurement was conducted at a room temperature and an electric quantity was 2.73 mA per an active material weight (g). The results are shown in FIG. 4 and FIG. 5.

FIG. 4 shows the charge and discharge curves of the second cycle in Examples 1, 2, Comparative Examples 1 and 2. As shown in FIG. 4, the charge and discharge capacities in Examples 1 and 2 were more excellent than those in Comparative Examples 1 and 2. Excellent charge and discharge capacities were not obtained in Comparative Examples 1 and 2presumably because the oxide films were present.

On the other hand, FIG. 5 shows the charge and discharge curves until third cycles in Examples 1 and 2. As shown in FIG. 5, the charge and discharge capacities in Example 1 were more excellent than those in Example 2. In addition, in Example 1, after the second cycle, stable charge and discharge capacities were shown and the charge overvoltage was decreased from the first cycle. Since the active material used in Example 1 did not have the oxide film and the active material used in Example 2 slightly had the oxide film, it was confirmed that the active material having the oxide film as little as it can was advantageous for improving the charge and discharge capacities and decreasing the charge overvoltage. The reason for the decrease in the charge overvoltage was presumably because F⁻ did not need to conduct high-resistant oxide film. Also, since the magnetic susceptibility of the active material used in Example 1 was higher than that of the active material used in Example 2, it was suggested that increasing the magnetic susceptibility inhibited the formation of the oxide film.

### REFERENCE SIGNS LIST

1 metal part
2 coating part
3 oxidation resistance region
10 active material
11 cathode active material layer
12 anode active material layer
13 electrolyte layer
14 cathode current collector
15 anode current collector
16 battery case
20 fluoride ion battery

What is claimed is:

1. An active material to be used for a fluoride ion battery, the active material comprising:
a metal part containing a metal element and capable of reaction with a fluoride ion; wherein
in O1s spectrum obtained by measuring a surface of the active material with an X-ray photoelectron spectroscopy, when an intensity at 531.0 eV is regarded as I_{A} and an intensity at a peak derived from an oxide of the metal element is regarded as I_{B}, I_{B}/I_{A} is 0 or more and 1 or less.

2. The active material according to claim 1, wherein the active material comprises the metal part and a coating part that covers the metal part.

3. The active material according to claim 2, wherein, in O1s spectrum obtained by measuring an interface between the metal part and the coating part with an X-ray photoelectron spectroscopy, when an intensity at 531.0 eV is regarded as I_{C} and an intensity at a peak derived from an oxide of the metal element is regarded as I_{D}, I_{D}/I_{C} is 0 or more and 1 or less.

4. The active material according to claim 2, wherein the coating part is a carbon coating part.

5. The active material according to claim 1, wherein the active material contains a Co element as the metal element.

6. The active material according to claim 5, wherein a magnetic susceptibility of the active material is 100 emu/g or more.

7. A fluoride ion battery comprising a cathode active material layer, an anode active material layer, and an electrolyte layer formed between the cathode active material layer and the anode active material layer; wherein
at least one of the cathode active material layer and the anode active material layer contains the active material according to claim 1.
